(19) United States
(12) Patent Application Publication
(10) Pub. No.: US 2015/0241981 A1
(43) Pub. Date: Aug. 27, 2015

(54) APPARATUS AND METHOD FOR RECOGNIZING USER GESTURE FOR VEHICLE

(71) Applicant: Hyundai Motor Company, Seoul (KR)

(72) Inventor: Gahee Kim, Seoul (KR)

(21) Appl. No.: 14/560,831

(22) Filed: Dec. 4, 2014

(30) Foreign Application Priority Data
Feb. 21, 2014 (KR) 10-2014-0020556

(51) Int. Cl. G06F 3/01; H04N 5/33; G06K 9/00; G01B 11/14

(52) U.S. Cl. CPC G06F 3/017; G01B 11/14; H04N 5/33; G06K 9/00355

(57) ABSTRACT

An apparatus and a method for recognizing a user gesture for a vehicle are provided. The apparatus includes an infrared imaging device that is configured to photograph a portion of a user body in a gesture recognition region and generate a plurality of images and an infrared emitting device that is configured to emit infrared rays toward the gesture recognition region. In addition, a controller is configured to adjust photographing times of the infrared imaging device, infrared emitting times and infrared emitting periods of the infrared emitting device, detect target objects that correspond to the portion of the user body from the plurality of images, synchronize the photographing times of the infrared imaging device with the infrared emitting times of the infrared emitting device, and determine a distance between the infrared imaging device and the target objects using brightness of the objects included in the plurality of images.

### CROSS-REFERENCE TO RELATED APPLICATION(S)

This application claims priority to and the benefit of Korean Patent Application No. 10-2014-0020556 filed in the Korean Intellectual Property Office on Feb. 21, 2014, the entire contents of which are incorporated herein by reference.

### BACKGROUND

(a) Field of the Invention

The present invention relates to an apparatus and a method for recognizing a user gesture.

(b) Description of the Related Art

Generally, a vehicle information device is a device that provides assistance for operating a vehicle or convenience and entertainment of a user, such as a driver. For example, the vehicle information device may be an audio video navigation (AVN) system, a telematics system, and the like. Recently, some vehicle information devices have been operated using a remote control method to prevent distracting a driver while operating the vehicle (e.g., eyes deviate from a road in front of a vehicle to operate buttons of the information devices).

A button disposed on a steering wheel, recognizing a user gesture, and the like have been developed as remote control methods. Among those, the recognition of a user gesture photographs a user hand using an imaging device and using a motion of the user hand as an intuitive button by analyzing the photographed image. To recognize a user three dimensional (3D) gesture including depth information, two imaging devices (e.g., a camera, a video camera, a stereo camera, or the like) or an additional distance sensor (e.g., an ultrasonic wave sensor) are required. However, when the two imaging devices or the distance sensor are used to recognize the user 3D gesture, production cost, power consumption, and installation space of an apparatus that recognizes the user 3D gesture may increase.

The above information disclosed in this section is merely for enhancement of understanding of the background of the invention and therefore it may contain information that does not form the prior art that is already known in this country to a person of ordinary skill in the art.

### SUMMARY

The present invention provides an apparatus and a method for recognizing a user gesture for a vehicle that may obtain depth (e.g., distance) information and recognize a user three dimensional (3D) gesture using one infrared imaging device.

An apparatus for recognizing a user gesture for a vehicle may include: an infrared imaging device (e.g., camera, video camera, and the like) configured to photograph a portion of a user body within a gesture recognition region and generate a plurality of images; an infrared emitting device configured to emit infrared rays toward the gesture recognition region; a controller configured to adjust photographing times of the infrared imaging device, infrared emitting times and infrared emitting periods of the infrared emitting device, detect target objects that correspond to the portion of the user body from the plurality of images, synchronize the photographing times of the infrared imaging device with the infrared emitting times of the infrared emitting device, and determine a distance between the infrared imaging device and target objects using brightness of the target objects included in the plurality of images. The infrared emitting periods may include a first infrared emitting period, a second infrared emitting period, and a third infrared emitting period that have different lengths.

The infrared imaging device may be configured transmit a first image photographed at a first photographing time that corresponds to the first infrared emitting period, a second image photographed at a second photographing time that corresponds to the second infrared emitting period, and a third image photographed at a third photographing time that corresponds to the third infrared emitting period to the controller, and the controller may be configured to determine the distance between the infrared imaging device and the portion of the user body using brightness difference between the target objects included in the first and second images, brightness difference between the target objects included in the second and third images, and brightness difference between the target objects included in the first and third images.

When brightness of any one of the target objects becomes a maximum value, the controller may be configured to determine an infrared emitting period that allows the brightness of the target objects to become the maximum value and the distance between the infrared imaging device and the portion of the user body based on the determined infrared emitting period. The controller may be configured to recognize a user 3D gesture by determining a change of the distance between the infrared imaging device and an image portion that corresponds to the portion of the user body.

A method for recognizing a user gesture may include: synchronizing, by a controller, photographing times of an infrared imaging device with infrared emitting times of an infrared emitting device; adjusting, by a controller, infrared emitting periods of the infrared emitting device; receiving, by the controller, a plurality of images from the infrared imaging device; detecting, by the controller, target objects that correspond to a portion of a user body from the plurality of images; and determining, by the controller, a distance between the infrared imaging device and target objects using brightness of the target objects included in the plurality of images.

The infrared emitting periods may include a first infrared emitting period, a second infrared emitting period, and a third infrared emitting period that have different lengths, and the reception of the plurality of images from the infrared imaging device may include receiving, by the controller, a first image photographed at a first photographing time that corresponds to the first infrared emitting period, a second image photographed at a second photographing time that corresponds to the second infrared emitting period, and a third image photographed at a third photographing time that corresponds to the third infrared emitting period from the infrared imaging device.

The determination of the distance between the infrared imaging device and the portion of the user body may include determining, by the controller, the distance between the infrared imaging device and the portion of the user body using brightness difference between the target objects included in the first and second images, brightness difference between the target objects included in the second and third images, and brightness difference between the target objects included in the first and third imaged.

The method may further include: determining, by the controller, an infrared emitting period that allows the brightness of the target objects to become the maximum value when brightness of any one of the target objects becomes a maximum value; and determining, by the controller, the distance between the infrared imaging device and the portion of the user body based on the determined infrared emitting period. The method may further include recognizing, by the controller, a user 3D gesture by determining a change of the distance between the infrared imaging device and the portion of the user body.

According to an exemplary embodiment of the present invention, the distance between the infrared imaging device and the portion of the user body may be determined using one infrared imaging device without using a stereo imaging device or a distance sensor. In addition, by using one infrared imaging, production cost, power consumption, and installation space of the apparatus for recognizing the user gesture may be reduced. Further, by using the infrared imaging device, the distance between the infrared imaging device and the portion of the user body may be determined more accurately without interference from an external light (e.g., sunlight, a streetlight, or a headlight of another vehicle).

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is an exemplary diagram of an apparatus for recognizing a gesture for a vehicle according to an exemplary embodiment of the present invention;

FIGS. 2A and 2B are exemplary drawings illustrating images, photographing times and infrared emitting times according to an exemplary embodiment of the present invention; and

FIG. 3 is an exemplary flow chart of a method for recognizing a gesture according to an exemplary embodiment of the present invention.

### DESCRIPTION OF SYMBOLS

10: Infrared imaging device;

20: Infrared emitting device

30: Controller

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described more fully with reference to the accompanying drawings, in which exemplary embodiments of the invention are shown. As those skilled in the art would realize, the described exemplary embodiments may be modified in various different ways, all without departing from the spirit or scope of the present invention. In addition, the drawings and description are to be regarded as illustrative in nature and not restrictive. Like reference numerals designate like elements throughout the specification.

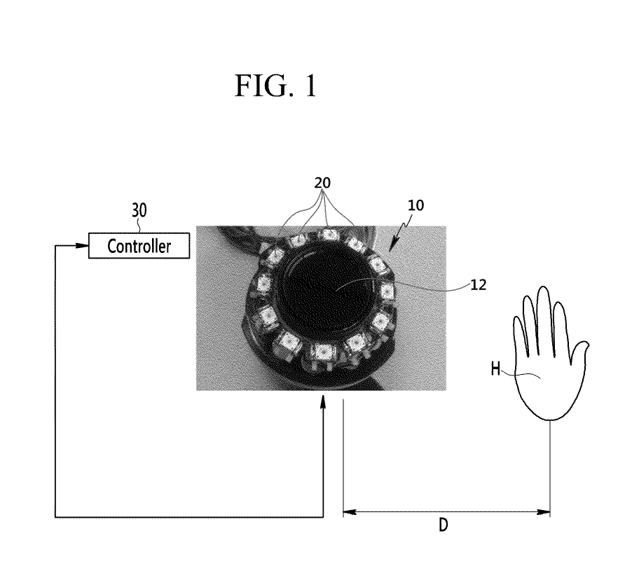

FIG. 1 is an exemplary diagram of an apparatus for recognizing a user gesture for a vehicle according to an exemplary embodiment of the present invention. Referring to FIG. 1, the apparatus for recognizing a user gesture may include an infrared imaging device (e.g. camera, video camera, and the like) 10, an infrared emitting device 20, and controller 30. The infrared imaging device 10 may be configured to photograph a portion of a user such as a user hand H within a gesture recognition region R and generate a plurality of images. The plurality of images may be transmitted to the controller 30. In the present specification and claims, it is to be understood that the infrared imaging device 10 may include any imaging device which may detect infrared rays reflected from the portion of the user. In particular, the infrared imaging device 10 may include an infrared band pass filter 12 that passes infrared rays. Additionally, photographing times of the infrared imaging device 10 may be adjusted by the controller 30.

The infrared emitting device 20 may be configured to emit infrared rays toward the gesture recognition region R based on a control of the controller 30. Infrared emitting times and infrared emitting periods of the infrared emitting device 20 may be adjusted by the controller 30. The controller 30 may be configured to synchronize the photographing times of the infrared imaging device 10 with the infrared emitting times of the infrared emitting device 20. Further, the controller 30 may be configured to detect target objects that correspond to the portion of the user body from the plurality of images and determine a distance between the infrared imaging device 10 and the target objects using brightness of the objects included in the plurality of images. In addition, the controller 30 may be configured to recognize a user 3D gesture by determining a change of the distance between the infrared imaging device 10 and the portion of the user body. For example, when the user hand moves in front and rear directions to execute a specific function of a vehicle information device, the controller 30 may be configured to recognize a tab gesture of the user by determining the change of the distance between the infrared imaging device 10 and the user hand.

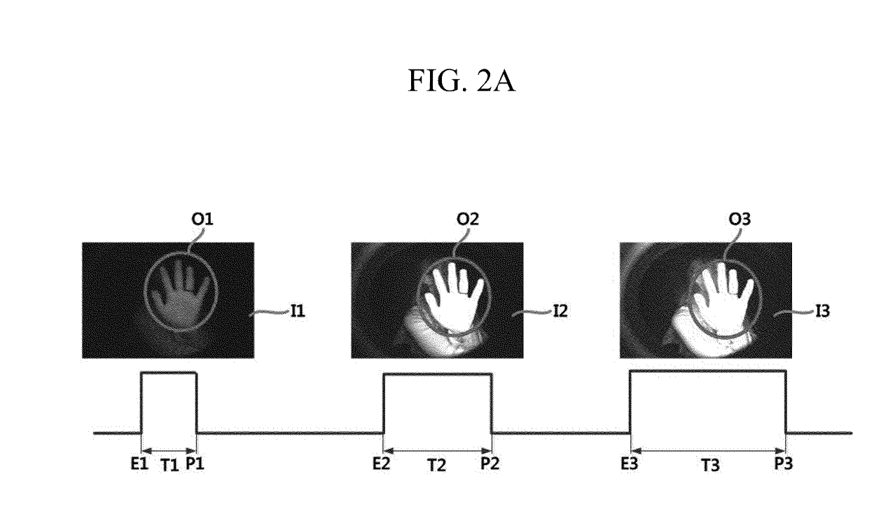

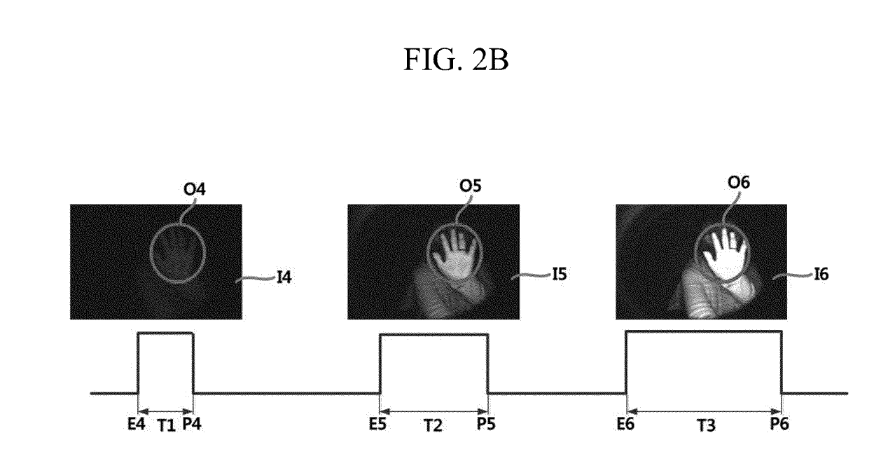

FIGS. 2A and 2B are exemplary drawings illustrating images, photographing times and infrared emitting times according to an exemplary embodiment of the present invention. FIG. 2A illustrates when the user hand is near (e.g., within a predetermined distance from) the infrared imaging device 10. Referring to FIG. 2A, infrared emitting times E1, E2, and E3 of the infrared emitting device 20 may be adjusted by the controller 30. At each of the infrared emitting times, the infrared emitting device 20 may be configured to emit infrared rays during each infrared emitting period. The infrared emitting periods may include a first infrared emitting period T1, a second infrared emitting period T2, and a third infrared emitting period T3 that have different lengths.

The photographing times P1, P2, and P3 of the infrared imaging device 10 may be adjusted by the controller 30. Further, the controller 30 may be configured to synchronize the photographing times P1, P2, and P3 with infrared emitting times E1, E2, and E3. The infrared imaging device may be configured to transmit a first image I1 photographed at the first photographing time P1 that corresponds to the first infrared emitting period T1, a second image I2 photographed at the second photographing time P2 that corresponds to the second infrared emitting period T2, and a third image I3 photographed at the third photographing time P3 that corresponds to the third infrared emitting period T3 to the controller 30.

The controller 30 may be configured to detect target objects O1, O2, and O3 that correspond to the user hand from the first, second, and third images I1, I2, and I3. Further, the controller 30 may also be configured to determine the distance between the infrared imaging device 10 and the user hand using brightness difference between the target objects O1 and O2 included in the first and second images I1 and I2, brightness difference between the target objects O2 and O3 included in the second and third images I2 and I3, and brightness difference between the target objects O1 and O3 included in the first and third images I1 and I3. In other words, when the brightness differences among the target objects O1, O2, and O3 are minimal (e.g., less than a predetermined value), the controller 30 may be configured to determine that the user hand is near (e.g., within a predetermined distance from) the infrared imaging device 10.

FIG. 2B illustrates when the user hand is far (e.g., farther than a predetermined distance from) from the infrared imaging device 10. Referring to FIG. 2B, infrared emitting times E4, E5, and E6 of the infrared emitting device 20 may be adjusted by the controller 30. At each of the infrared emitting times, the infrared emitting device 20 may be configured to emit infrared rays during each infrared emitting period. The infrared emitting periods may include the first infrared emitting period T1, the second infrared emitting period T2, and the third infrared emitting period T3 having different lengths.

The photographing times P4, P5, and P6 of the infrared imaging device 10 may be adjusted by the controller 30. In addition, the controller 30 may be configured to synchronize the photographing times P4, P5, and P6 with the infrared emitting time E4, E5, and E6. The infrared imaging device 10 may be configured to transmit a fourth image 14 photographed at the fourth photographing time P4 that corresponds to the first infrared emitting period T1, a fifth image I5 photographed at the fifth photographing time P5 that corresponds to the second infrared emitting period T2, and a sixth image I6 photographed at the sixth photographing time P6 that corresponds to the sixth infrared emitting period T6 to the controller 30.

The controller 30 may be configured to detect target objects O4, O5, and O6 that correspond to the user hand from the fourth, fifth, and sixth images I4, I5, and I6. Further, the controller 30 may be configured to determine the distance between the infrared imaging device 10 and the user hand using brightness difference between the target objects O4 and O5 included in the fourth and fifth image I4 and I5, brightness difference between the target objects O5 and O6 included in the fifth and sixth images I5 and I6, and brightness difference between the target objects O4 and O6 included in the fourth and sixth images I4 and I6. In other words, when brightness differences among the target objects O4, O5, and O6 are substantially increased (e.g., greater than a predetermined value), the controller 30 may be configured to determine that the user hand is far from the infrared imaging device 10.

Meanwhile, a maximum value of brightness of the target objects may be stored within the controller 30. When brightness of any one of the target objects is the maximum value, the controller may be configured to determine the infrared emitting period that allows the brightness of the target objects to become the maximum value and the distance between the infrared imaging device 10 and the user hand based on the determined infrared emitting period. For example, when brightness of the target objects O2, O3, and O6 included in the second, third, and sixth images I2, I3, and I6 becomes the maximum value, the controller 30 may be configured to determine the user hand is near the infrared imaging device 10 based on the second and third infrared emitting periods T2 and T3 or the user hand is far from the infrared imaging device 10 based on the third infrared emitting period T3.

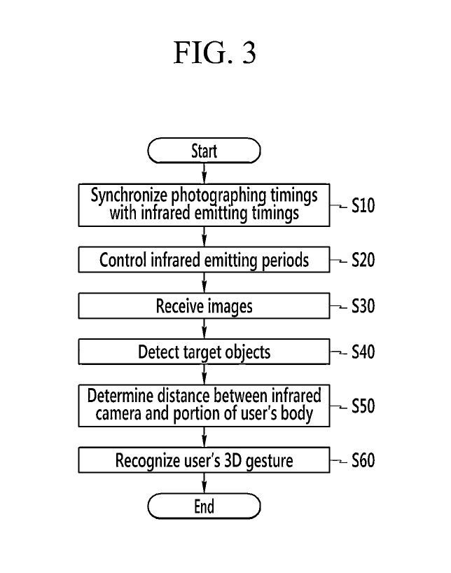

FIG. 3 is an exemplary flow chart of a method for recognizing a user gesture according to an exemplary embodiment of the present invention. The controller 30 may be configured to synchronize photographing times of the infrared imaging device 10 with infrared emitting times of the infrared emitting device 20 (S10). In addition, the controller 30 may be configured to adjust infrared emitting periods of the infrared emitting device 20 (S20). Further, the controller 30 may be configured to receive the plurality of images from the infrared imaging device 10 (S30). The controller 30 may also be configured to detect the target objects that correspond to the portion of the user body (e.g., the user hand) from the plurality of images (S40).

Furthermore, the controller 30 may be configured to determine the distance between the infrared imaging device 10 and the portion of the user body using brightness of the target objects included in the plurality of images (S50). In particular, the controller 30 may be configured to determine the distance between the infrared imaging device 10 and the portion of the user body using the brightness differences between the target objects included in the plurality of images. In addition, when brightness of any one of the target objects becomes the maximum value, the controller 30 may be configured to determine the infrared emitting period that allows the brightness of the target objects to become the maximum value and the distance between the infrared imaging device 10 and the portion of the user body based on the determined infrared emitting period.

Further, the controller 30 may be configured to recognize the user 3D gesture by determining the change of the distance between the infrared imaging device 10 and the portion of the user body (S60). For example, when the user hand is moved in front and rear directions to execute a specific function of the vehicle information device, the controller 30 may be configured to recognize the tab gesture of the user by determining the change of the distance between the infrared imaging device 10 and the user hand.

As described above, according to exemplary embodiments of the present invention, the distance between the infrared imaging device 10 and the portion of the user body may be determined using one infrared imaging device 10 without using a stereo imaging device or a distance sensor. In addition, by using one infrared imaging device, production cost, power consumption, and installation space of the apparatus for recognizing the user gesture may be reduced. Further, by using the infrared imaging device, the distance between the infrared imaging device 10 and the portion of the user body may be determined more accurately without interference from an external light (e.g., sunlight, a streetlight, or a headlight of another vehicle).

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. An apparatus for recognizing a user gesture for a vehicle, comprising:
an infrared imaging device configured to:
photograph target objects of a user body within a gesture recognition region; and
generate a plurality of images;
an infrared emitting device configured to emit infrared rays toward the gesture recognition region; and
a controller configured to:
adjust photographing times of the infrared imaging device, infrared emitting times and infrared emitting periods of the infrared emitting device;
detect target objects that correspond to a portion of the user body from the plurality of images,
synchronize the photographing times of the infrared imaging device with the infrared emitting times of the infrared emitting device; and
determine a distance between the infrared imaging device and the target objects using brightness of the objects included in the plurality of images.

2. The apparatus of claim 1, wherein the infrared emitting periods include a first infrared emitting period, a second infrared emitting period, and a third infrared emitting period that have different lengths.

3. The apparatus of claim 2, wherein the infrared imaging device is configured to transmit:
a first image photographed at a first photographing time that corresponds to the first infrared emitting period,
a second image photographed at a second photographing time that corresponds to the second infrared emitting period, and
a third image photographed at a third photographing time that corresponds to the third infrared emitting period to the controller, and
the controller is further configured to:
determine the distance between the infrared imaging device and the target objects using a brightness difference between the target objects included in the first and second images, a brightness difference between the target objects included in the second and third images, and a brightness difference between the target objects included in the first and third images.

4. The apparatus of claim 3, wherein when brightness of the target objects becomes a maximum value, the controller is further configured to:
determine an infrared emitting period that allows the brightness of the target objects to become the maximum value; and
determine the distance between the infrared imaging device and the target objects based on the determined infrared emitting period.

5. The apparatus of claim 1, wherein the controller is further configured to:
recognize a three dimensional (3D) gesture by determining a change of the distance between the infrared imaging device and the target objects.

6. A method for recognizing a gesture for a vehicle, comprising:
synchronizing, by a controller, photographing times of an infrared imaging device with infrared emitting times of an infrared emitting device;
adjusting, by the controller, infrared emitting periods of the infrared emitting device;
receiving, by the controller, a plurality of images from the infrared imaging device;
detecting, by the controller, target objects that correspond to a portion of a user body from the plurality of images; and
determining, by the controller, a distance between the infrared imaging device and the target objects using brightness of the target objects included in the plurality of images.

7. The method of claim 6, wherein the infrared emitting periods includes a first infrared emitting period, a second infrared emitting period, and a third infrared emitting period having different lengths, and
the reception of the plurality of images from the infrared imaging device includes:
receiving, by the controller, a first image photographed at a first photographing time that corresponds to the first infrared emitting period, a second image photographed at a second photographing time that corresponds to the second infrared emitting period, and a third image photographed at a third photographing time that corresponds to the third infrared emitting period from the infrared imaging device.

8. The method of claim 7, wherein the determination of the distance between the infrared imaging device and the target objects includes:
determining, by the controller, the distance between the infrared imaging device and the target objects using a brightness difference between the target objects included in the first and second images, a brightness difference between the target objects included in the second and third images, and a brightness difference between the target objects included in the first and third images.

9. The method of claim 8, further comprising:
determining, by the controller, an infrared emitting period that allows the brightness of the target objects to become a maximum value when a brightness of any one of the target objects becomes then maximum value; and
determining, by the controller, the distance between the infrared imaging device and the target objects based on the determination of the infrared emitting period.

10. The method of claim 6, further comprising:
recognizing, by the controller, a three dimensional (3D) gesture by determining a change of the distance between the infrared imaging device and the portion of the user body.

11. A non-transitory computer readable medium containing program instructions executed by a controller, the computer readable medium comprising:
program instructions that synchronize photographing times of an infrared imaging device with infrared emitting timings of an infrared emitting device;
program instructions that adjust infrared emitting periods of the infrared emitting device;
program instructions that receive a plurality of images from the infrared imaging device;
program instructions that detect target objects that correspond to a portion of a user body from the plurality of images; and
program instructions that determine a distance between the infrared imaging device and the target objects using brightness of the target objects included in the plurality of images.

12. The non-transitory computer readable medium of claim 11 wherein the infrared emitting periods includes a first infrared emitting period, a second infrared emitting period, and a third infrared emitting period having different lengths, and
the program instructions that receive the plurality of images from the infrared imaging device include:
program instructions that receive a first image photographed at a first photographing time that corresponds to the first infrared emitting period, a second image photographed at a second photographing time that corresponds to the second infrared emitting period, and a third image photographed at a third photographing time that corresponds to the third infrared emitting period from the infrared imaging device.

13. The non-transitory computer readable medium of claim 12 wherein the program instructions that determine the distance between the infrared imaging device and the target objects includes:
program instructions that determine the distance between the infrared imaging device and the target objects using a brightness difference between the target objects included in the first and second images, a brightness difference between the target objects included in the second and third images, and a brightness difference between the target objects included in the first and third images.

14. The non-transitory computer readable medium of claim 13, further comprising:
program instructions that determine an infrared emitting period that allows the brightness of the target objects to become a maximum value when a brightness of any one of the target objects becomes then maximum value; and
program instructions that determine the distance between the infrared imaging device and the target objects based on the determination of the infrared emitting period.

15. The non-transitory computer readable medium of claim 11, further comprising:
program instructions that recognize a three dimensional (3D) gesture by determining a change of the distance between the infrared imaging device and the portion of the user body.
